(19) United States
(12) Patent Application Publication
(10) Pub. No.: US 2026/0269297 A1
(43) Pub. Date: Sep. 10, 2026

(54) ELECTROCHEMICAL SYSTEM INCLUDING SEPARATE REACTION AND CABINET EXHAUST DUCTS AND METHOD OF OPERATING THEREOF

(71) Applicant: Bloom Energy Corporation, San Jose, CA (US)

(72) Inventors: Rueben M. KEMPTON, San Jose, CA (US); Nicholas VARAMO, Philadelphia, PA (US); Samuel JUDAY, Tahoe City, CA (US); Lorenzo PENNA, San Jose, CA (US); Jessica MAHLER, Palo Alto, CA (US); Joseph TAVI, Danville, CA (US)

(21) Appl. No.: 19/548,337

(22) Filed: Feb. 24, 2026

Related U.S. Application Data
(60) Provisional application No. 63/767,234, filed on Mar. 5, 2025.

(51) Int. Cl. H01M 8/2475; H01M 8/04014; H01M 8/0662; H01M 8/2484

(52) U.S. Cl. CPC H01M 8/2475; H01M 8/04014; H01M 8/0662; H01M 8/2484

(57) ABSTRACT

A generator module includes a support frame, power modules disposed in the support frame and arranged in rows, each power module including a hotbox cabinet housing a hotbox and least one stack of electrochemical cells disposed in the hotbox, and an electronics cabinet housing system electronics, reaction exhaust (RE) ducts extending through the support frame between the rows of power modules, the RE ducts fluidly connected to exhaust conduits of the hotboxes and configured to receive RE from the hotboxes via the exhaust conduits, and cabinet exhaust (CE) ducts extending through the support frame between the rows of power modules, the CE ducts configured to receive CE from the hotbox cabinets.

### TECHNICAL FIELD

The present disclosure generally relates to an electrochemical cell system, and more particularly, to an electrochemical cell system containing separate reaction and cabinet exhaust ducts.

### BACKGROUND

An electrochemical system, such as fuel cell system or an electrolyzer system, may include electrochemical modules, such as fuel cell modules including one or more fuel cell stacks or electrolyzer modules including one or more electrolyzer stacks.

### SUMMARY

According to an aspect of the present disclosure, a generator module includes a support frame, power modules disposed in the support frame and arranged in rows, each power module including a hotbox cabinet housing a hotbox and least one stack of electrochemical cells disposed in the hotbox, and an electronics cabinet housing system electronics, reaction exhaust (RE) ducts extending through the support frame between the rows of power modules, the RE ducts fluidly connected to exhaust conduits of the hotboxes and configured to receive RE from the hotboxes via the exhaust conduits, and cabinet exhaust (CE) ducts extending through the support frame between the rows of power modules, the CE ducts configured to receive CE from the hotbox cabinets.

According to another aspect of the present disclosure, a method of operating a fuel cell generator module comprising a support frame and power modules disposed in the support frame and arranged in rows is provided. The method comprises providing fuel and air to fuel cell stacks disposed in respective hotboxes located in respective hotbox cabinets of the power modules; providing direct current (DC) power from the fuel cell stacks to DC/DC converters located in respective electronics cabinets of the power modules; providing fuel exhaust and air exhaust from the fuel cell stacks to anode tail oxidizers located in the respective hotboxes; oxidizing the fuel exhaust using the air exhaust in the anode tail gas oxidizers to generate a reaction exhaust (RE); providing the RE from the hotboxes to RE ducts extending through the support frame between the rows of power modules; and providing hotbox cabinet exhaust (CE) from the hotbox cabinets to CE ducts extending through the support frame between the rows of power modules.

### BRIEF DESCRIPTION OF THE DRAWINGS

The accompanying drawings, which are incorporated herein and constitute part of this specification, illustrate examples of the disclosed devices and methods, and together with the general description given above and the detailed description given below, serve to explain the features of the invention.

FIG. 1A is a schematic view of a fuel cell system power module, according to various embodiments of the present disclosure, and FIG. 1B is a perspective view of the power module with a module door removed.

FIG. 2A is side view of a generator module, according to various embodiments of the present disclosure, FIG. 2B is a top schematic view of the generator module of FIG. 2A, and FIG. 2C is a cross-sectional view taken along line L1 of FIG. 2B.

FIG. 3A is a side view of a generator assembly including stacked generator modules, according to various embodiments of the present disclosure, FIG. 3B is a perspective view of the generator assembly of FIG. 3A with some power modules removed, FIG. 3C is a cross-sectional perspective view taken along plane P1 of FIG. 3B, and FIG. 3D is a schematic cross-sectional view taken along plane P1 of FIG. 3B.

FIG. 4 is a perspective view of a combined heat and power (CHP) system, according to various embodiments of the present disclosure.

### DETAILED DESCRIPTION

Various examples will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims. It is also understood that the examples shown in the figures are not mutually exclusive. Features shown in one example (e.g., in one figure) may be included in other examples (e.g., in other figures).

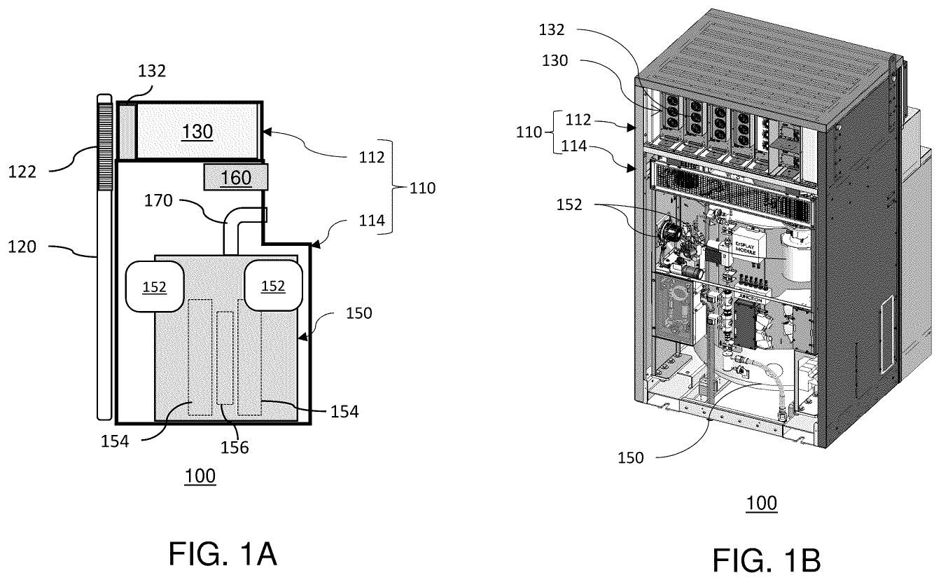

FIG. 1A is a schematic view of a fuel cell system power module 100, according to various embodiments of the present disclosure, and FIG. 1B is a perspective view of the power module 100 with a module door removed. Referring to FIGS. 1A and 1B, the module 100 includes a housing 110 and a door 120 configured to provide access to the housing 110. The housing 110 may be formed of a metal and may be divided into an electrical cabinet 112 and a hotbox cabinet 114. The electrical cabinet 112 is shown stacked on top of the hotbox cabinet 114. In alternative embodiments, the electrical cabinet 112 may be provided below the hotbox cabinet 114 or the hotbox cabinet 114 and the electrical cabinet 112 may be arranged side by side. The door 120 may include a vent 122 to provide air to the electrical cabinet 112 and/or the hotbox cabinet 114.

The electrical cabinet 112 may include one or more electronics modules 130, which may each include one or more fans 132. The electronics modules 130 may also include power conditioning electronics for the fuel cell stack(s), such as DC/DC converters, control elements (e.g., controller logic devices), sensors, or the like. The fans 132 may pull ambient air through the vent 122 and into the electrical cabinet to cool the electronics modules 130.

The hotbox cabinet 114 may include a hotbox 150, balance of plant (BOP) components 152, a ventilation unit 160, and exhaust conduits 170. The hotbox 150 may include one or more fuel cell stacks 154 or columns of fuel cell stacks 154, heat exchangers, an anode tail gas oxidizer 156, and fluid conduits, such as pipes and/or manifolds through which various process streams (e.g., fuel, air, fuel exhaust, air exhaust, water, etc.) flow. In one embodiment, the fuel cell stacks may be arranged in the hotbox 150 in one or more columns of fuel cell stacks 154, such as one or more columns of solid oxide fuel cells (SOFCs) having a ceramic oxide electrolyte separated by conductive interconnects. Other fuel cell types, such as Proton Exchange Membrane (PEM), molten carbonate, phosphoric acid, etc., may also be included in the hotbox 150 instead of or in addition to SOFCs. A fuel cell column may include one fuel cell stack or plural fuel cell stacks 154 arranged in series (e.g., stacked vertically over one another). The fuel cell stacks may include externally and/or internally manifolded stacks. For example, the fuel cell stacks may be externally manifolded for air and internally manifolded for fuel with fuel riser opening extending through openings in the fuel cell layers and/or in the interconnects between the fuel cells. The fuel may include a hydrogen containing fuel, such as hydrogen gas or ammonia, or hydrocarbon fuel, such as natural gas, methane, biogas, etc.

In one embodiment, a method of operating the power modules 100 includes providing fuel and air to the fuel cell stacks 154, providing direct current (DC) power from the fuel cell stacks 154 to DC/DC converter electronic modules 130 located in respective electronics cabinets 112 of the power modules 100, providing a fuel exhaust and an air exhaust from the fuel cell stacks 154 to the anode tail oxidizer 156 located in the hotbox 150, oxidizing the fuel exhaust using the air exhaust in the anode tail gas oxidizer 156 to generate a reaction exhaust (RE) which is output from the hotbox 150 via an exhaust conduit 170.

The BOP components 152 may include blowers, valves, conduits, etc., located outside the hotbox 150. For example, the BOP components 152 may include an air inlet blower that provides an air inlet stream into the hotbox 150, and a fuel recycle blower that recycles the fuel cell stack anode exhaust into a fuel inlet stream provided into the fuel cell stack. The BOP components 152 may be attached to sidewalls of the housing 110.

The ventilation unit 160 may be configured to pull relatively cool cabinet exhaust (CE) from inside of the hotbox cabinet 114 and exhaust the CE out of the backside of the module housing 110. For example, the ventilation unit 160 may include a fan or a blower configured to generate air flow through the hotbox cabinet 114. The CE flows between the hotbox 150 and the inner walls of the hotbox cabinet 114, but does not flow inside the hotbox 150.

The exhaust conduits 170 may be fluidly connected to the hotbox 150 and may extend out of the backside of the module housing 110. The exhaust conduits 170 may be configured to receive the relatively hot RE generated in the hotbox 150 (e.g., in the anode tail gas oxidizer 156). As noted above, the hot RE may comprise an anode tail gas oxidizer exhaust, which is generated by oxidation of the fuel cell stack fuel exhaust using the fuel cell stack air exhaust.

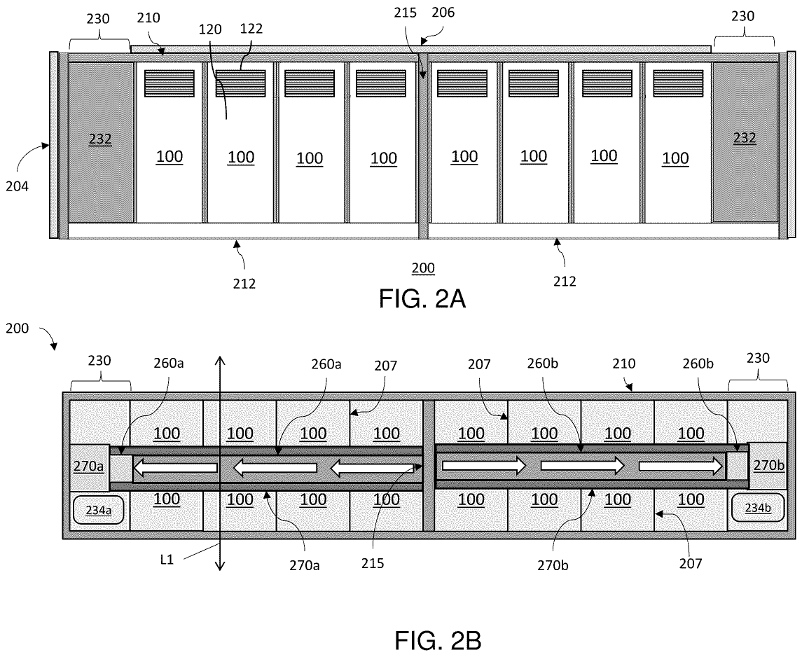

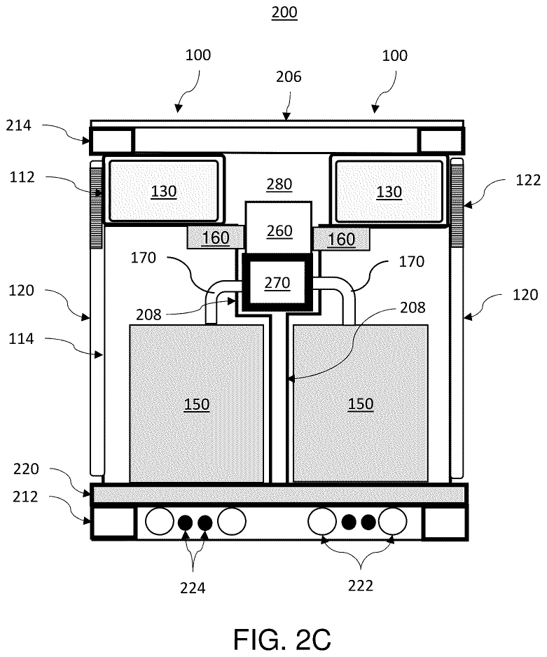

FIG. 2A is side view of generator module 200, according to various embodiments of the present disclosure, FIG. 2B is a top schematic view of the generator module 200 of FIG. 2A, and FIG. 2C is a cross-sectional view taken along line L1 of FIG. 2B.

Referring to FIGS. 2A-2C, the generator module 200 may include power modules 100 disposed in a support frame 210. The support frame 210 may comprise a plurality of vertical and horizontal rails (e.g., beams) that are attached to each other using any suitable attachment method, such as welding, bolting, clamping, or the like. Alternatively, the support frame 210 may comprise a unitary component formed from a metal or a metal alloy.

The generator module 200 may include sidewalls 204 and a roof 206 that are attached to the support frame 210. The sidewalls 204 and the roof 206 may be formed of a metal or a metal alloy, and may be attached to the support frame 210 using any suitable attachment method, such as welding, bolting, clamping, or the like. Alternatively, the sidewalls 204 and/or the roof 206 may comprise part of the same unitary component as the support frame 210.

Optionally, hotbox cabinet walls 207 may extend across the support frame 210 parallel to the sidewalls 204 and perpendicular to the long axis of the generator module 200. Furthermore, one or more optional cabinet back walls 208 (see FIG. 2C) may extend along the long axis of generator module 200 to separate the space inside the support frame 210 in half. The space between two adjacent cabinet walls 207, the back wall 208, the door 120, and the roof 206 forms the hotbox cabinet 114 of one power module 100. The power modules 100 may be arranged back-to-back in the support frame 210, such that the power modules 100 are disposed in parallel rows which are separated by the back walls 208.

Accessory compartments 230 may be located adjacent to the sidewalls 204 (e.g., between a respective sidewall 204 and the adjacent cabinet wall 207). The accessory compartments 230 may be laterally sealed by access panels or doors 232, the cabinet walls 207 and the sidewalls 204. In various embodiments, the accessory compartments 230 may include additional system components 234a and 234b. For example, one accessory compartment 230 may include electrical components 234a, such as DC power connectors, power routers, etc. The electrical components 234a may electrically connect the DC power output from the power modules 100 (e.g., from the electronics modules 130) to external power conditioning equipment, such as a central DC/AC inverter(s), transformer(s) and/or telemetry equipment which provides control signals from a central monitoring facility to the generator module(s) 200. The other accessory compartment 230 located on the opposite end of the generator module 200 may include fluid processing components 234b, such as fuel conduits, water conduits, valves, etc. The fuel conduits may be fluidly connected to a central desulfurizer system located separately from the generator module 200.

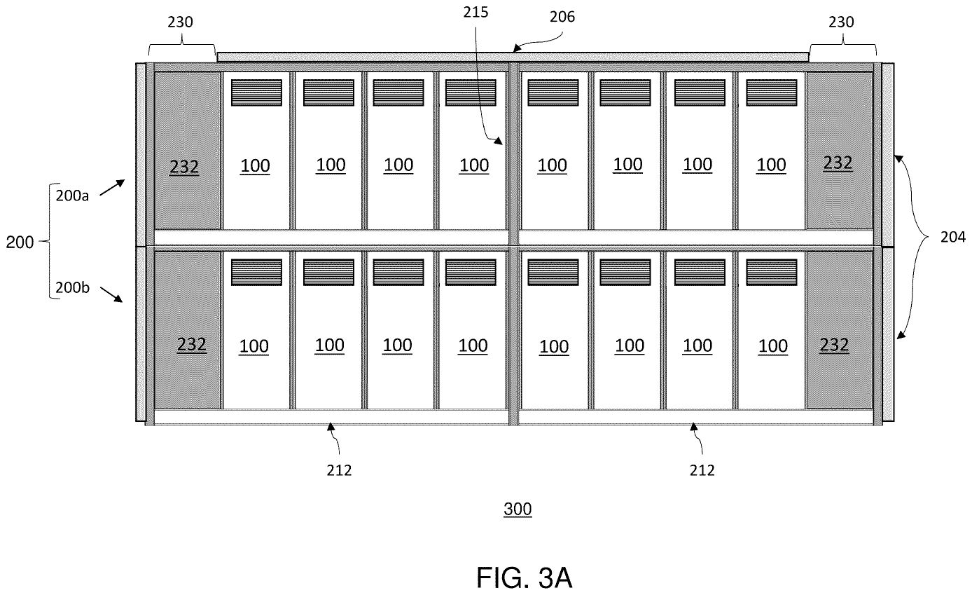

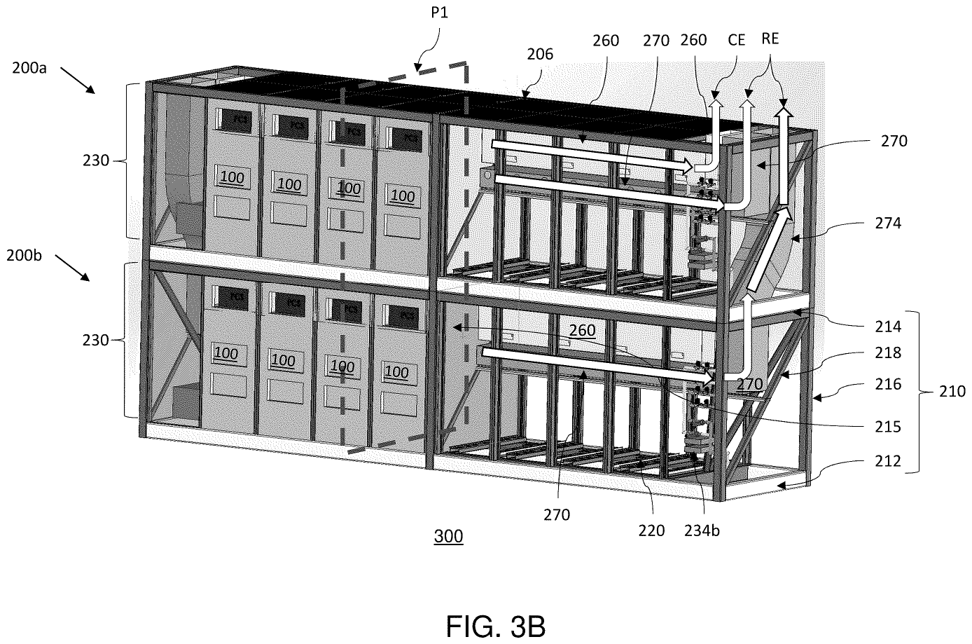

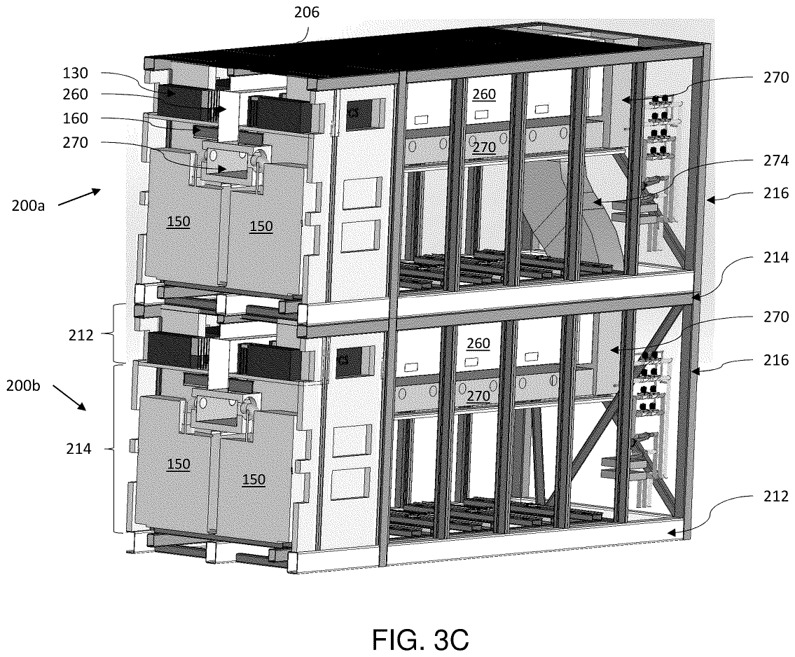

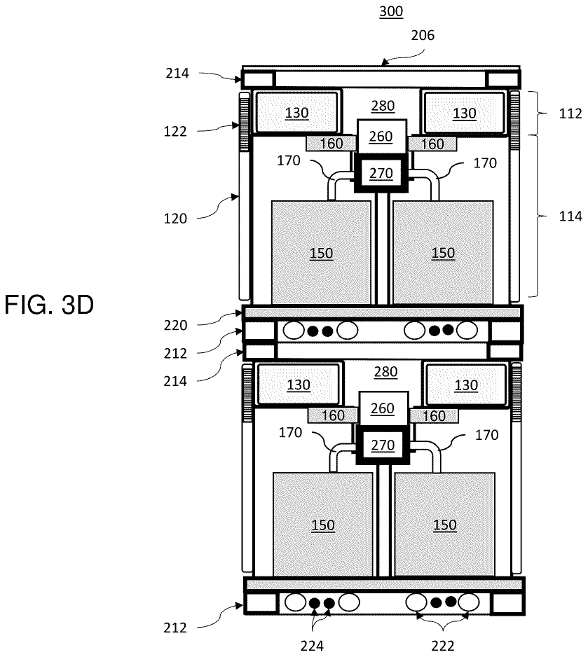

The support frame 210 may include base rails 212, top rails 214, side rails 216 (see FIG. 3B), and cross braces 218 (see FIG. 3B). The roof 206 may be disposed on the top rails 214. Module rails 220 may be disposed on the base rails 212. The module rails 220 may extend perpendicular to the base rails 212 and may be configured to support the hotboxes 150. In particular, the hotboxes 150 may be configured to slide on the module rails 220 when inserted into or removed from the generator module 200. The support frame 210 may optionally include a central support wall 215, which may be a divider disposed between groups of the power modules 100. The central support wall 215 may be configured to strengthen the support frame 210 to facilitate lifting and/or movement of the generator module 200. The central support wall 215 may extend vertically perpendicular to the long direction of the generator module 200, and separate the generator module 200 into two exhaust duct sections as will be described in more detail below.

The generator module 200 may include fuel and/or water conduits 222 that extend between the base rails 212 of the support frame 210 and that fluidly connect the fluid processing components 234b to the power modules 100 (e.g., to the hotboxes 150 of the power modules). The generator module 200 may also include electrical wiring 224 that extends between the base rails 212 and that electrically connects the power modules 100 (e.g., the electronics modules 130) to the electrical components 234a.

The generator module 200 may include cabinet exhaust (CE) ducts 260 (e.g., first and second CE ducts 260a, 260b), and reaction exhaust (RE) ducts 270 (e.g., first and second RE ducts 270a, 270b). The CE ducts 260 may extend horizontally through the support frame 210 along the long axis of the generator module 200, from opposing sides of the central support wall 215, before extending vertically up to the top of the generator module 200. In particular, the CE ducts 260 may extend horizontally between the rows of power modules 100, and then may extend vertically through the accessory compartments 230.

The CE ducts 260 may be configured to receive CE from a corresponding group of power module 100 hotbox cabinets 114. For example, the first CE duct 260a may receive CE from power modules 100 disposed to the left of the central support wall 215, and the second CE duct 260b may receive CE from power modules 100 disposed to the right of the central support wall 215. In particular, ventilation units 160 of each power module 100 may force CE from each hotbox cabinet 114 into the corresponding CE duct 260.

In one embodiment, the CE duct 260a is not fluidly connected to the other CE duct 260b, and the CE ducts do not extend through the central support wall 215. Therefore, ends of the CE ducts 260 located adjacent to the central support wall 215 may be sealed, and opposing ends of the CE ducts 260 may be open and disposed adjacent to the roof 206. Accordingly, CE may flow in opposite directions in the first and second CE ducts 260a, 260b, as shown by the arrows in FIG. 2B. CE then flows vertically through the respective CE ducts inside the corresponding accessory compartments 230 and being exhausted from the generator module 200 to atmosphere, since CE consists of relatively cool air collected from the hotbox cabinets 114. In some embodiments, exhaust fans or blowers may optionally be disposed in the CE ducts 260 to increase CE flow rates. Air filters (not shown) may optionally be disposed in the CE ducts 260.

The RE ducts 270 may be configured to receive RE from a corresponding group of the power modules 100 (e.g., from a group of hotboxes 150 located in the corresponding group of power modules 100). For example, the first RE duct 270a may receive RE from power modules 100 disposed to the left of the central support wall 215, and the second RE duct 270b may receive RE from power modules 100 disposed to the right of the central support wall 215. In particular, exhaust conduits 170 of each power module 100 may output RE from each hotbox 150 into a corresponding RE duct 270. The RE ducts 270 may be thermally insulated to reduce cooling of the RE. For example, the RE ducts 270 may be covered with a heat-resistant thermal insulation material.

In one embodiment, the RE ducts 270 are not fluidly connected to the CE ducts 260. Furthermore, in one embodiment, the RE duct 270a is not fluidly connected to the other RE duct 270b, and the RE ducts do not extend through the central support wall 215. Therefore, ends of the RE ducts 270 disposed adjacent to the central support wall 215 may be sealed, and opposing ends of the RE ducts 270 may be open and disposed adjacent to the roof 206. Accordingly, RE may flow in opposite directions in the first and second RE ducts 270a, 270b, as shown by the arrows in FIG. 2B. RE then flows vertically through the respective RE ducts inside the corresponding accessory compartments 230 before being exhausted from the generator module 200. Filters (not shown), such as electrostatic particulate filters, may may optionally be disposed in the RE ducts 270. In one embodiment, the RE ducts 270 are disposed below the CE ducts 260,

In various embodiments, the generator module 200 may include electronics exhaust (EE) ducts or chambers 280 that are configured to receive EE output from the electrical cabinets 112. In some embodiments, the EE ducts 280 may be formed between the power modules 100 and above the CE ducts 260 and the RE ducts 270. The EE ducts 280 may vent the EE out of the side of the generator module 200.

FIG. 3A is a side view of a generator assembly 300 including vertically stacked generator modules 200, according to various embodiments of the present disclosure, FIG. 3B is a perspective view of the generator assembly 300 of FIG. 3A with some power modules removed, FIG. 3C is a cross-sectional perspective view taken along plane P1 of FIG. 3B, and FIG. 3D is a schematic cross-sectional view taken along plane P1 of FIG. 3B. The generator modules 200 may be similar to the generator modules 200 of FIGS. 2A-2C. As such, only the differences there between will be discussed in detail.

Referring to FIGS. 3A-3D, the generator assembly 300 may include sidewalls 204 and a roof 206 which corresponds to the roof 206 disposed on the topmost generator module 200 in the generator assembly 300. The generator modules 200 may include an upper generator module 200a that is vertically stacked on a lower generator module 200b. Each generator module 200 may include two rows of power modules 100 disposed back-to-back in respective support frame 210, and accessory compartments 230 disposed on opposing sides of the power modules 100.

As discussed above, and as shown in FIG. 3B, each support frame 210 may include base rails 212, top rails 214, a central support wall 215, side rails 216, and cross braces 218. The base rails 212 and top rails 214 may extend horizontally and the side rails 216 may extend vertically to connect the base and top rails 212, 214. The cross braces 218 may extend diagonally between the base and top rails 212, 214 to increase the lateral stiffness of the support frame 210.

Each generator module 200 may include CE ducts 260 and RE ducts 270 as described above with respect to FIGS. 2B and 2C. The generator assembly 300 may also include RE extension ducts 274. The RE extension ducts 274 may be fluidly connected to the RE ducts 270 of the lower generator module 200b and may extend through the accessory compartments 230 of the upper generator module 200a to the top of the generator assembly 300. Accordingly, RE from both of the generator modules 200 may be emitted at the top of the generator assembly 300. In other words, RE may be emitted from opposing sides of the top of the upper generator module 200a from corresponding groups of power modules 100.

CE may be provided from the hotbox cabinets 114 to a corresponding CE duct 260 by the ventilation units 160. The CE generated in the lower generator module 200b may be output to the accessory compartments 230 and then exhausted from the top or the generator assembly 300, via the corresponding CE ducts 260. The CE generated in the upper generator module 200a may be output directly from opposing sides of the top of the generator assembly 300, via the corresponding CE ducts 260. In one embodiment, the CE duct 260 of the lower generator module 200b may be fluidly connected to the CE duct 260 of the upper generator module 200a by a CE extension duct (not shown).

EE output from the electrical cabinets 112 may be provided to the accessory compartments 230 via the respective EE ducts 280. The EE may be output from the side or top of the generator assembly 300.

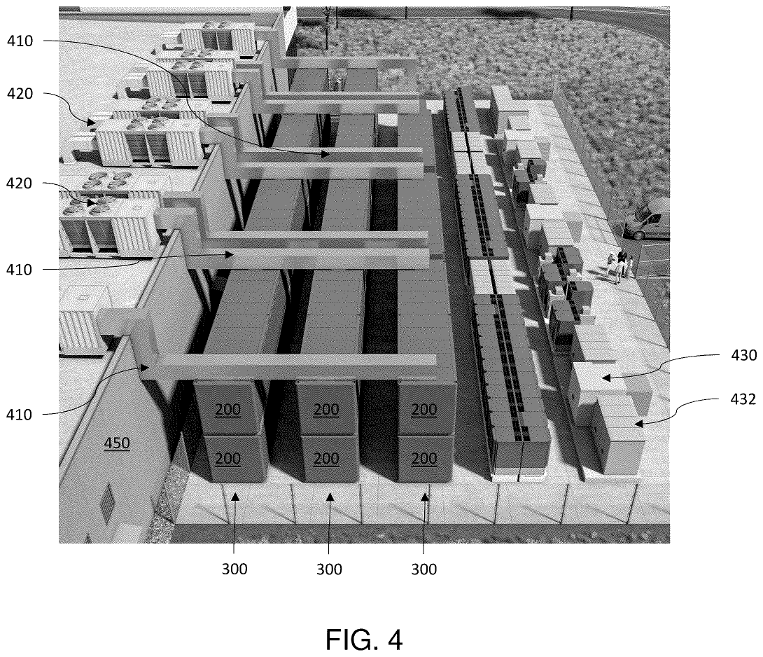

FIG. 4 is a perspective view of a combined heat and power (CHP) system 400, according to various embodiments of the present disclosure. Referring to FIGS. 3A and 4, the CHP system 400 may include at least one generator assembly 300 (such as plural generator assemblies), assembly ducts 410, and heat exchangers 420. The assembly ducts 410 may be configured to provide RE output from RE ducts 270 of the generator assemblies 300 to the heat exchangers 420. The heat exchangers 420 may be configured to utilize the hot RE to heat water and/or air provided to an adjacent structure 450, such as a residential, commercial or manufacturing building or building campus. In some embodiments, the heat exchangers 420 may be located on the roof of the structures 450, while the assembly 300 is located on the ground adjacent to the structure 450. In this embodiment, the assembly ducts 410 may include vertical portions which extend to the roof of the structure 450.

In one embodiment, the heat exchangers 420 may comprise heat pumps. In other embodiments the heat exchangers 420 may be integrated into absorption chillers which use the hot RE to chill water. In another embodiment, the heat exchangers 420 can be arranged in a heat transfer relationship with one or more heat recovery steam generators, such that the heat exchangers 420 may also be used to generate steam at various pressures in the heat recovery stream generator.

The generator assemblies 300 may also provide electricity to the structure 450 and/or to a power grid. In one embodiment, the heat exchangers 420 can be arranged in a heat transfer relationship with and/or integrated into an organic Rankine cycle generator, such that the generator converts the heat from the heat exchangers 420 to additional electricity using the organic Rankine cycle (ORC).

The CHP system 400 may optionally include other centralized system components, such as at least one central power conditioning module 430 and/or at least one central fuel processing module 432. The power conditioning module 430 may include one or more cabinets that contain components (e.g., DC/AC inverter) for converting DC power generated by the power modules 100 to AC power, electrical connectors for AC power output to a power grid, a transformer, circuits for managing electrical transients, and a system controller (e.g., a computer or dedicated control logic device or circuit). The power conditioning module 430 may be connected by wires or electrical buses to the electrical components 234a of each generator module 200.

The fuel processing module 432 may include one or more cabinets which contain components used for pre-processing a fuel, such as, for example, adsorption beds (e.g., de-sulfurizer and/or other impurity adsorption beds). The fuel processing module 430 may also be used for post-processing the fuel, in which recycled hydrogen (e.g., either recycled hydrogen fuel or a hydrogen containing fuel exhaust stream) from the fuel cell modules 100 is provided to the fuel processing module 432 for purification, storage, recycling into the fuel inlet stream and/or use outside the system 400. The fuel processing module 432 may process at least one of the following fuels: natural gas provided from a pipeline, compressed natural gas, methane, propane, liquid petroleum gas, gasoline, diesel, home heating oil, kerosene, JP-5, JP-8, aviation fuel, hydrogen, ammonia, ethanol, methanol, syn-gas, biogas, biodiesel and other suitable hydrocarbon or hydrogen containing fuels. The fuel processing module 432 may be fluidly connected with the power modules 100 via the fluid processing components 234b in each generator module 200 to provide processed fuel (e.g., de-sulfurized and/or purified fuel) to the power modules 100.

According to various embodiments, the generator assemblies and generator modules have a compact configuration that allows for a higher power density and a reduced site footprint. In particular, the generator assemblies may include stacked generator modules having internal exhaust handling components. The exhaust handling components allow for the output of high temperature RE and low temperature CE and/or EE as separate streams. As such, higher temperature RE may be provided for CHP applications without being diluted with cooler CE. Various embodiments also provide improved site level thermal performance. In particular, RE exhaust may be emitted at a high velocity and temperature, which improves exhaust dispersal and reduces exhaust recirculation to system inlets.

While fuel cell power systems are described above, in an alternative embodiment, electrolyzer cell systems may be disposed in the generator assemblies. In this alternative embodiment, electrolyzer cell stacks, such as solid oxide electrolyzer cell stacks, may be disposed in the hotboxes 150. The electrolyzer cell stacks convert steam into hydrogen and oxygen by electrolysis. Therefore, the generator modules 100 comprise hydrogen generator modules which output a hydrogen containing product stream and a hot oxygen-enriched air RE stream into the RE conduits 270. The hot oxygen-enriched air RE stream comprises a mixture of sweep air mixed with the oxygen generated by the electrolysis of steam.

Fuel cell and electrolyzer cell systems of the embodiments of the present disclosure are designed to reduce greenhouse gas emissions and have a positive impact on the climate.

Although only a few examples have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative examples. Other substitutions, modifications, changes, and omissions may also be made in the configuration, operating conditions and arrangement of the various examples without departing from the scope of the present disclosure. Any one or more features of any example may be used in any combination with any one or more other features of one or more other examples. It is intended that the specification and examples be considered as exemplary only, with a true scope being indicated by the following claims and their equivalents.

What is claimed is:

1. A generator module, comprising:
a support frame;
power modules disposed in the support frame and arranged in rows, each power module comprising:
a hotbox cabinet housing a hotbox and least one stack of electrochemical cells disposed in the hotbox; and
an electronics cabinet housing system electronics;
reaction exhaust (RE) ducts extending through the support frame between the rows of power modules, the RE ducts fluidly connected to exhaust conduits of the hotboxes and configured to receive RE from the hotboxes via the exhaust conduits; and
cabinet exhaust (CE) ducts extending through the support frame between the rows of power modules, the CE ducts configured to receive CE from the hotbox cabinets.

2. The generator module of claim 1, further comprising ventilation units disposed in each of the hotbox cabinets and configured to provide CE into the CE ducts.

3. The generator module of claim 1, wherein:
the support frame comprises accessory compartments disposed on opposing ends of the support frame; and
the RE and CE ducts extend horizontally between the rows of power modules and then extend vertically through corresponding accessory compartments to a top of the generator module.

4. The generator module of claim 3, wherein:
the CE ducts comprise a first CE duct that is fluidly connected to a first group of the power modules and a second CE duct that is fluidly connected to a second group of the power modules;
the RE ducts comprise a first RE duct that is fluidly connected to the first group of power modules and a second RE duct that is fluidly connected to the second group of power modules;
CE and RE from the first group of power modules are configured to flow through the first CE duct and the first RE duct, respectively, in a first direction; and
CE and RE from the second group of power modules are configured to flow through the second CE duct and the second RE duct, respectively, in a second direction that is opposite to the first direction.

5. The generator module of claim 4, wherein:
the support frame comprises a central support wall that extends between the first and second CE ducts, the first and second RE ducts, and the first and second groups of power modules;
the first and second CE ducts do not extend through the central support wall; and
the first and second RE ducts do not extend through the central support wall.

6. The generator module of claim 3, further comprising a roof disposed on top of the support frame, wherein ends of the CE and RE ducts extend through the roof.

7. The generator module of claim 1, further comprising electronics exhaust (EE) ducts extending through the support frame between the rows of power modules, the EE ducts configured to receive EE from corresponding electronics cabinets.

8. The generator module of claim 1, wherein the support frame comprises:
base rails and top rails that extend in a first horizontal direction; and
side rails that extend in a vertical direction to connect the base rails and the top rails.

9. The generator module of claim 8, further comprising module rails that extend in a second horizontal direction perpendicular to the first horizontal direction, wherein the module rails connect the base rails and support the hotboxes.

10. The generator module of claim 1, wherein each of the power modules further comprises:
a door; and
a vent disposed in the door and configured to provide ambient air to the power module.

11. The generator module of claim 1, wherein the at least one stack of electrochemical cells comprises at least one stack of fuel cells.

12. A generator assembly comprising:
a first generator module which comprises the generator module of claim 1; and
a second generator module vertically stacked on the first generator module.

13. The generator assembly of claim 12, further comprising:
comprising a roof disposed on top of the second generator module; and
RE extension ducts that extend from the RE ducts of the first generator module, through the second generator module, and through the roof.

14. The generator assembly of claim 12, wherein in each of the first and second generator modules:
the support frame comprises accessory compartments disposed on opposing ends of the support frame; and
the RE and CE ducts extend horizontally between the rows of power modules and then extend vertically through corresponding accessory compartments.

15. The generator assembly of claim 12, further comprising:
a central fuel processing module configured to purify fuel provided to the power modules of the first and the second generator modules; and
a central power conditioning module containing a direct current (DC) to alternating current (AC) inverter configured receive (DC power generated by the power modules, and to convert the DC power to AC power.

16. A combined heat and power (CHP) system comprising:
the generator assembly of claim 12;
a heat exchanger; and
assembly ducts configured to provide RE output from the generator assembly to the heat exchanger.

17. A method of operating a fuel cell generator module comprising a support frame and power modules disposed in the support frame and arranged in rows, the method comprising:
providing fuel and air to fuel cell stacks disposed in respective hotboxes located in respective hotbox cabinets of the power modules;
providing direct current (DC) power from the fuel cell stacks to DC/DC converters located in respective electronics cabinets of the power modules;
providing fuel exhaust and air exhaust from the fuel cell stacks to anode tail oxidizers located in the respective hotboxes;
oxidizing the fuel exhaust using the air exhaust in the anode tail gas oxidizers to generate a reaction exhaust (RE);
providing the RE from the hotboxes to RE ducts extending through the support frame between the rows of power modules; and
providing hotbox cabinet exhaust (CE) from the hotbox cabinets to CE ducts extending through the support frame between the rows of power modules.

18. The method of claim 17, wherein:
the CE ducts comprise a first CE duct that is fluidly connected to a first group of the power modules and a second CE duct that is fluidly connected to a second group of the power modules;
the RE ducts comprise a first RE duct that is fluidly connected to the first group of power modules and a second RE duct that is fluidly connected to the second group of power modules;
CE and RE from the first group of power modules flow through the first CE duct and the first RE duct, respectively, in a first direction;
CE and RE from the second group of power modules flow through the second CE duct and the second RE duct, respectively, in a second direction that is opposite to the first direction;
the support frame comprises a central support wall that extends between the first and second CE ducts, the first and second RE ducts, and the first and second groups of power modules;
the first and second CE ducts do not extend through the central support wall; and
the first and second RE ducts do not extend through the central support wall.

19. The method of claim 17, further comprising an additional fuel cell generator module vertically stacked on the fuel cell generator module.

20. The method of claim 19, further comprising providing the RE from the fuel cell generator module and the additional fuel cell generator module to at least one heat exchanger located on a roof of building.
